(19) United States
(12) Patent Application Publication
(10) Pub. No.: US 2025/0108327 A1
(43) Pub. Date: Apr. 3, 2025

(54) SORBENT MEMBRANES WITH CONDUCTIVE LAYER FOR EFFICIENT SORBENT REGENERATION

(71) Applicant: Battelle Memorial Institute, Columbus, OH (US)

(72) Inventors: Krenar SHQAU, Westerville, OH (US); Katherine M. PALMER, Galloway, OH (US); Philip DENEN, Reynoldsburg, OH (US); Amy HEINTZ, Pacific Grove, CA (US); Kevin YUGULIS, Columbus, OH (US); David R. CHASE, Gahanna, OH (US)

(73) Assignee: BATTELLE MEMORIAL INSTITUTE, Columbus, OH (US)

(21) Appl. No.: 18/900,525

(22) Filed: Sep. 27, 2024

Related U.S. Application Data
(60) Provisional application No. 63/586,706, filed on Sep. 29, 2023.

(51) Int. Cl. B01D 53/22; B01D 69/10

(52) U.S. Cl. CPC B01D 53/228; B01D 69/1071; B01D 2257/504; B01D 2321/32; B01D 2325/0283; B01D 2325/04

(57) ABSTRACT

The present disclosure provides regenerative sorbent membranes and membrane assemblies for direct air capture (DAC) systems for CO₂ capture, wherein the sorbent membranes have a conductive film disposed thereon. The conductive film provides a means for direct heating of the sorbent membrane to desorb captured CO₂ and regenerate the membrane. The conductive films are comprised of carbon nanotubes (CNTs) and a polymeric binder. Methods of making a regenerative sorbent membrane for direct air capture systems are also disclosed.

### CROSS-REFERENCE TO RELATED APPLICATIONS

This application claims benefit and priority to U.S. Provisional Patent Application No. 63/586,706, filed on Sep. 29, 2023, titled “Sorbent Membranes With Conductive Layer For Efficient Sorbent Regeneration”, the disclosure of which is incorporated herein in its entirety.

### FIELD OF INVENTION

The present invention relates to structures and methods for effective regeneration of sorbent membranes used in gas separation systems. More specifically, the invention pertains to direct air capture (DAC) sorbent membranes having a direct contact heating layer for effective desorption (regeneration) of the membrane.

### BACKGROUND

Direct capture of carbon dioxide (CO₂) from the air (direct air capture, or DAC) is one among a variety of emerging technologies which are expected to tackle the growing problem of greenhouse gases being released into the atmosphere. Extensive deployment of the DAC technologies is needed to mitigate and remove so-called legacy carbon or historical emissions. Effective reduction of the CO₂ content in the atmosphere would be achieved only by extracting very large amounts of CO₂ that are comparable to that of the current global emissions. Current DAC technologies are mainly based on sorbent-based systems where CO₂ is trapped on the surface of the porous solid membranes functionalized with the compounds having high CO₂ affinity. These processes are currently rather expensive, although the cost is expected to go down as the technologies are developed and deployed at scale. Although an important design variable of a practical DAC technology is to maximize the capture efficiency of selected sorbent materials. The regeneration procedure, however, dictates the system overall energy requirements, which must be minimized for realistic and scaled DAC operations.

Temperature swing adsorption (TSA) is the method most commonly used for CO₂ capture and desorption processes. During this method, once CO₂ is captured onto the sorbent membrane, a desorption or regeneration step needs to occur to release the CO₂ from the membrane and then collect the released CO₂. This requires that the sorbent is heated to a temperature of about 80 to 150 degrees Celsius. Generally, air or inert-gas purge is applied for regenerating the sorbent membrane in conventional TSA process. Typically a large amount of purge gas is supplied to the DAC module to increase the temperature of the sorbent membrane within a short time. To reduce the flow rate of the purge and cycle time, electric-swing adsorption (ESA), temperature-vacuum-swing adsorption (TVSA), and indirect heating using hollow-fiber adsorbents or heat exchangers have been proposed and investigated, with each method or system having drawbacks or flaws. Some drawbacks of the current system include the high energy required for heating the parts of DAC modules which do not participate in regeneration of membrane (such as housing, fixture, etc.).

A localized means for heating the membrane is required, so as to minimize energy costs for individual and scaled systems, and to reduce the negative impact of temperature cycling which can occur on materials and components of DAC modules which are not involved in CO₂ adsorption and desorption, but are continuously heated as part of the regeneration process.

Additionally, a means for heating the sorbent membranes in a more efficient and quicker manner is needed (as compared to traditional heating means), so as to reduce the cycle time for each adsorption/desorption step, and to provide a higher overall operating efficiency to DAC modules.

### SUMMARY

The present disclosure generally relates to regenerative sorbent membranes used in direct air capture (DAC) systems and methods for efficient membrane desorption and regeneration. The membranes disclosed herein have a conductive layer disposed directly thereon. This allows for direct and efficient heating of the membrane surface, without having to rely on external heating means. Heating of the membrane allows for desorption of gas species which are captured by the membrane, allowing for the membrane to be regenerated, and then reused again in the next cycle of operation.

In one embodiment of the present invention, a regenerative sorbent membrane is disclosed for CO₂ capture from a gas stream. The membrane comprises a support layer, a mesoporous layer and a sorbent which has moiety with CO₂ affinity. The regenerative sorbent membrane further comprises a conductive film layer. The conductive film layer provides heat to the regenerative sorbent membrane for release of CO₂ captured by the sorbent. The conductive film layer is in direct contact with the regenerative sorbent membrane. The direct contact for the conductive film layer provides direct heating to the sorbent. Heating of the sorbent allows for desorption of the CO₂ which is captured on the membrane, which thereby regenerates the membrane.

In other embodiments, a regenerative sorbent membrane is disclosed, comprising an inner support layer and at least one sorbent layer having CO₂ affinity, disposed on the inner support layer. In some embodiments, a first and second sorbent layer can be disposed on either side of the inner support layer. The regenerative sorbent membrane further comprises at least one conductive film layer, comprising carbon nanotubes (CNTs), and disposed on the sorbent layer(s). In certain embodiments, a first conductive film layer is disposed on one side of the regenerative sorbent membrane and a second layer is disposed on the opposite side of the regenerative sorbent membrane, with each layer disposed on the sorbent layers of the membrane.

### Selected Definitions

As used herein, “weight percent,” “wt. %, “percent by weight,” “% by weight,” and variations thereof refer to the concentration of a substance as the weight of that substance divided by the total weight of the composition and multiplied by 100.

As used herein, “molar percent,” “mol %”, “percent by mol,” and variations thereof refer to the relative content of a substance as the mole of that substance divided by the total mole of the composition and multiplied by 100.

As used herein, “volumetric percent,” “vol %”, “percent by volume,” and variations thereof refer to the relative content of a substance as the mole of that substance divided by the total volume of the composition and multiplied by 100.

As used herein, “g” represents gram; “L” represents liter; “mg” represents “milligram (10-3 gram);” “μg” equals to one microgram (10-6 gram). “mL” or “cc” represents milliliter (10-3 liter). One “μL” equals to one microliter (10-6 liter). The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

As used herein, “mils” represents 1/100^{th} of an inch. 1 micron is equivalent to 0.039 mils. The measurement mil is used throughout the disclosure to quantify a wet coating thickness.

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention.

Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### BRIEF DESCRIPTION OF THE DRAWINGS

FIG. 1 shows a schematic of operations of a direct air capture (DAC) system, with the top figure showing air input into a DAC system, with CO₂ being absorbed in a membrane and CO₂ free air outputted. The bottom figure shows a CO₂ removal step.

FIG. 2 depicts a schematic of a typical (prior art) solid sorbent membrane used in DAC systems for removal of CO₂ from incoming air stream. CO₂ is trapped or adsorbed on a top layer of the membrane which has affinity for CO₂.

FIG. 3A shows a schematic of regenerative sorbent membranes having a conductive film layer disposed thereon, in accordance with various embodiments of the present disclosure. A CO₂ capture process is shown on the left, and a CO₂ desorption (membrane regeneration) process is shown on the right.

FIG. 3B shows chemical structures of exemplary second hydrophilic monomers or exemplary less hydrophilic functional groups of the second hydrophilic monomer described herein, in accordance with various embodiments of the present disclosure.

FIG. 4 depicts a cross-sectional view of a simplified regenerative sorbent membrane having a conductive film layer disposed thereon, in accordance with various embodiments of the present disclosure

FIG. 5A shows a graph on the effect that a conductive film layer in accordance with embodiments of the present disclosure, has on the gas permeance of a substrate.

FIG. 5B shows a graph which correlates the required electrical power (watts) to the surface temperature achievable in a conductive film layer, in accordance with embodiments of the present disclosure.

FIG. 6A shows a graph of a conductive film layer heating profile, which outlines the heating rate per seconds. The graph depicts that a fast heating rate is achieved, with a conductive film layer capable of reaching 90 degrees Celsius within 15 seconds.

FIG. 6B shows a comparative graph of heating profile of a substrate with traditional heating means (i.e. external heating, without a conductive film layer disposed thereon). Using traditional heating means, the substrate reached 90 degrees Celsius in 45 seconds.

FIG. 7 depicts a transfer film coating process for preparing conductive film layers disclosed herein and attaching them onto a porous substrate.

FIG. 8 shows a schematic of an SSGP testing method for determining gas permeance of a substrate coated with a conductive layer, in accordance with embodiments of the present disclosure.

FIG. 9A is a cross-sectional, side view of regenerative sorbent membrane, in accordance with embodiments of the present disclosure.

FIG. 9B is a cross-sectional top view of an assembly of a multiplicity of regenerative sorbent membranes, in accordance with embodiments of the present disclosure.

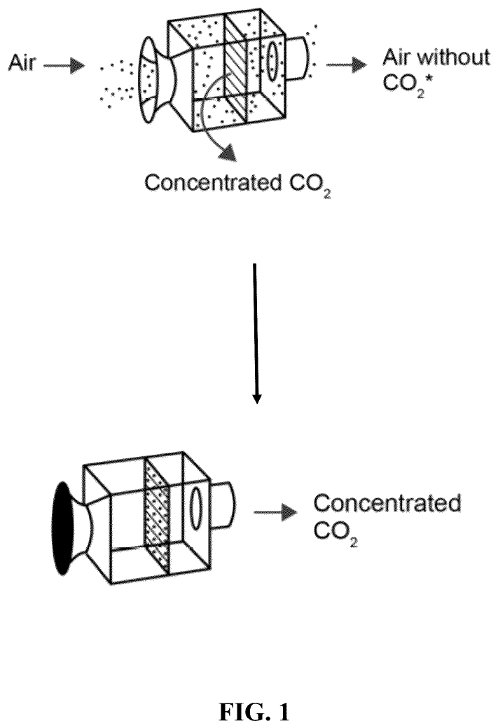

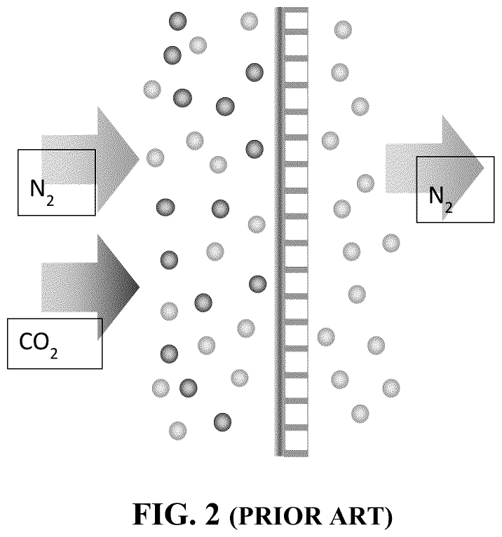

### DETAILED DESCRIPTION

The present disclosure generally relates to regenerative sorbent membranes used in direct air capture (DAC) systems and methods for efficient membrane desorption and regeneration. The membranes disclosed herein have a conductive layer disposed directly thereon. This allows for direct and efficient heating of the membrane surface, without having to rely on external heating means. Heating of the membrane allows for desorption of gas species which are captured by the membrane, allowing for the membrane to be regenerated, and then reused again in the next cycle of operation.

In one embodiment of the present invention, a regenerative sorbent membrane is disclosed for CO₂ capture from a gas stream. The membrane comprises a support layer, a mesoporous layer and a sorbent which has moiety with CO₂ affinity. The regenerative sorbent membrane further comprises a conductive film layer. The conductive film layer provides heat to the regenerative sorbent membrane for release of CO₂ captured by the sorbent. The conductive film layer is in direct contact with the regenerative sorbent membrane. The direct contact for the conductive film layer to provide direct heating to the sorbent. Heating of the sorbent allows for desorption of the CO₂ which is captured on the membrane, which regenerates the membrane.

In one embodiment, the conductive film layer comprises carbon nanotubes, a polymeric binder, and a dispersing agent. Preferably, the carbon nanotubes (CNTs) are uniformly dispersed within a polymeric binder. The CNTs can be selected from single-walled CNTs, double-walled, or multi walled CNTs, or fullerenes, or combinations thereof. Other nano-metallic or graphitic materials which possesses effective conductivity can also be incorporated. In some embodiments, a combination of conductive materials listed herein can be utilized within the conductive film layer. Single-walled and multi-walled carbon nanotubes are preferred for use in the present invention as they exhibit high conductivity due to their graphitic carbon structure and nanoscale size, they exhibit high thermal stability, are non-corrosive, light-weight, and are readily dispersed in solvents and polymeric matrixes.

The carbon nanotubes are present in the conductive film layer in about 30-60 wt % of the total contents of the film layer. In one embodiment, the carbon nanotubes are present in about 35-55 wt %, or about 40-50 wt %, or any value therebetween. The polymeric binder is present in the conductive film layer in about 1-10 wt %. A dispersing agent, such as for example carboxymethyl cellulose (CMC) is incorporated in the composition of the conductive layer, which aids in the uniform dispersion of the CNTs. The dispersing agent can be present in the final coating in about 40-60 wt %. Optional curing agents, rheology modifies, stabilizing agents, and other functional additives can also be incorporated in the composition of the conductive film layer.

The polymer binder preferably contains a polymer which is capable of eliminating humidity effects on the conductive layer's performance and has good heat resistance properties. For example, in one embodiment, a water-borne alkaline acrylic polymer emulsion may be used as the polymer binder component of the conductive film layer (e.g. Rhoplex I 545, available from Dow Chemicals). In other embodiments, an acrylonitrile butadiene polymer (elastomer) can be utilized as the polymeric binder component (e.g. Nipol, available from Zeon Chemicals).

In some embodiments, the conductive film layer has a thickness of about 1.0 μm-50 μm. The thickness of the conductive film layer will vary depending on the type of membrane, and the required heating conditions for that sorbent. In some embodiments, the conductive film layer has a thickness of about 5-45 μm, or about 10-35 μm, or about 15-25 μm, or any value therebetween. In other embodiments, the conductive film layer thickness is about 1-10 μm, or about 1-8 μm, or about 1-6, or about 1-5 μm, or any value therebetween.

The regenerative sorbent membrane of claim 1, wherein the conductive film layer has conductivity of about 800 to 1,500 S/m and a heating rate of about 7° C. to 10° C. per second, with about 100 to 170 mW/Sq.cm of power required for the conductive film to reach a temperature of 100 degrees Celsius. The conductive layer resistance can range from about 1 to 7 Ohms. Preferably, the conductive layer has a resistance of about 4-5 Ohms, which will allow for achieving a rapid heating rate of about 100 degrees per minute.

In certain embodiments, the conductive film layer is breathable so that the passage of gas through the sorbent membrane is not inhibited by the conductive film layer. For example, in particular embodiments, the conductive layer exhibits a gas permeance (f) of about 7e-4 mol·s⁻¹·Pa⁻¹·m⁻². Preferably, the conductive layer has a gas permeance that is about 10-20% higher than that of the regenerative sorbent substrate, or the micro-porous layer of the sorbent membrane.

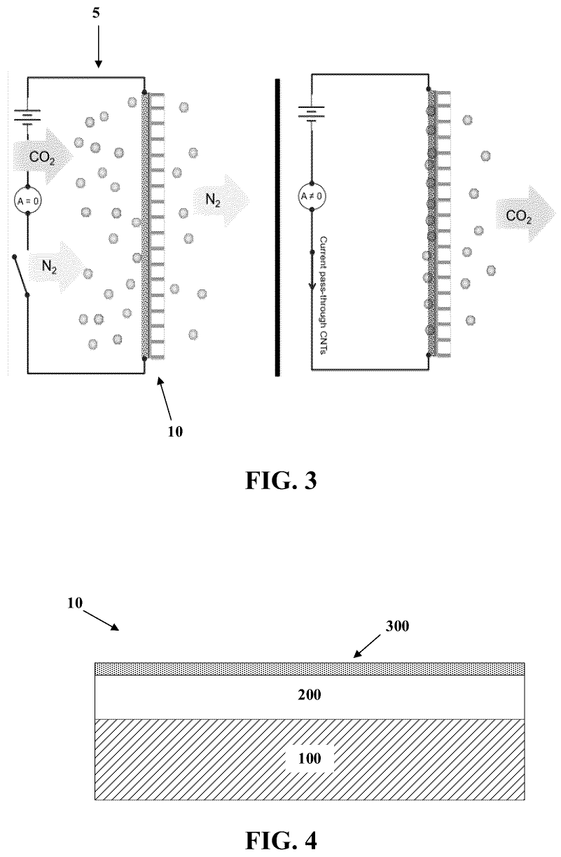

Shown in FIGS. 3 and 4 are embodiments of the regenerative sorbent membranes disclosed herein. In FIG. 3, a schematic workflow is shown of how a membrane 10 would function in a DAC system. Air comprising pollutants such as CO₂ is passed through the membrane 10, having the conductive film layer thereon, as disclosed in embodiments of the present invention. The conductive film layer is not in a heated mode at this stage as no current is being passed through the layer during a gas separation step of the DAC system. As CO₂ is passing through the regenerative sorbent membrane 10 it is being trapped in the membrane layer which has a CO₂ affinity moiety or reactivity. This allows for the rest of the air components of the gas stream to pass through and exit the DAC system as a clean air stream. The air stream in this schematic is being represented by N₂ for the sake of simplicity, since air is predominantly comprised of nitrogen. Once enough CO₂ has been captured, the gas stream is halted and it is time to desorb the CO₂ from the membrane and thereby regenerate the membrane so that it can be active for use in further CO₂ capture cycles. A current is applied to the conductive film, via electrical leads 5, so that the conductive layer can be heated to a desired temperature for CO₂ desorption to occur. This temperature is typically between about 80-150 degrees Celsius. Once the temperature is reached in the conductive film and the membrane which is in contact with the film, the temperature is held for a period of time that is effective for CO₂ release and regeneration of the sorbent membrane. The time and temperature of this step will vary depending on the level of saturation for CO₂ and on the type of membrane used.

Shown in FIG. 4 is a cross-sectional schematic of a simplified regenerative sorbent membrane 10, in accordance with some embodiments of the present invention. In some embodiments, the membranes disclosed herein have a variety of layers, which make up the sorbent membrane 10, including a macroporous layer 100, mesoporous layer 200 and conductive film layer 300. Coupled to the conductive film layer 300 are a pair of electrode leads (element 5 in FIG. 3), which are utilized to cycle a current through the film layer 300 and to thereby resistively heat the conductive film layer 300 during a desorption step.

In certain embodiments, the sorbent membrane 10 comprises a sorbent material which is either incorporated and dispersed within a mesoporous layer 200 or resides on the surface of a mesoporous layer 200, or a combination thereof. Below the mesoporous layer 200, the substrate macroporous layer 100 acts as a support structure of the entire sorbent membrane 10.

In some embodiments, the sorbent membrane 10 can comprise a zeolite, a metal organic framework (MOF), alumina, silica, silica alumina, titania, activated carbon, organically modified ceramic materials, organic polymers, or a combination thereof. Many types of sorbent membranes can be utilized with the conductive film layer disposed thereon, as long as the sorbent membrane is the solid type regenerative membrane which utilizes a heating process to desorb captured gas species, once heated.

The macroporous support layer of the sorbent membrane 10 can have an average pore size, Øp, of greater than about 50 nm and a thickness of about 500 microns to 5 mm. The mesoporous layer has an average pore size between about 2-50 nm and thickness of about 1 micron to 100 micron. In a preferred embodiment, the mesoporous layer has a thickness of about 2-20 microns. In some embodiments, a sorbent is dispersed onto the mesoporous layer, and resides dispersed within the mesoporous layer. In other embodiments, a sorbent is disposed on the surface and subsurface portions of the mesoporous layer, forming a thin sorbent layer, having average pore size of less than about 2 nm. The macroporous support layer or mesoporous layer or sorbent can comprise a zeolite, a metal organic framework (MOF), gamma alumina, silica, silica alumina, titania, zirconia, activated carbon, organically modified ceramic materials, organic polymers, or a combination thereof.

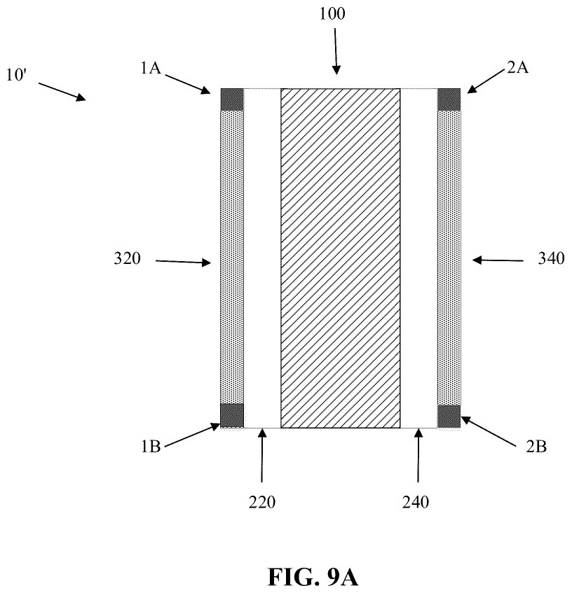

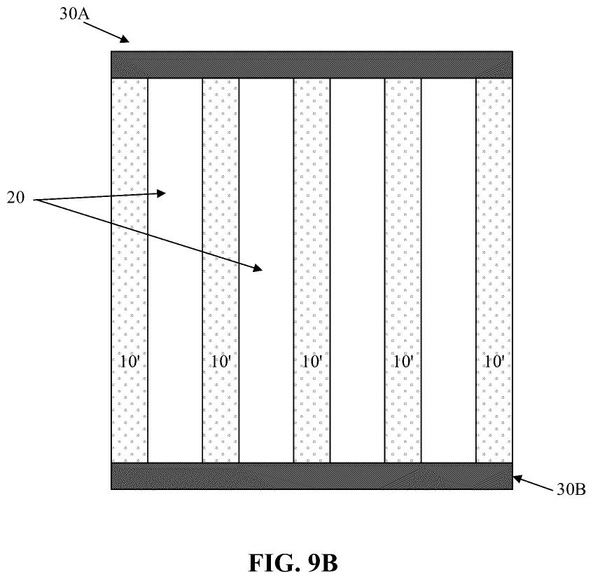

In a further embodiment, as shown in FIGS. 9A and 9B, a regenerative sorbent membrane 10′ is disclosed, comprising: an inner support layer 100 and at least one sorbent layer (220 and 240 in FIG. 9A) having CO₂ affinity, disposed on the inner support layer. A first and second sorbent layer can be disposed on either side of the inner support layer 100. The sorbent membrane 10′ further comprises at least one conductive film layer (layers 320 and 340), comprising carbon nanotubes (CNTs), and disposed on the at least one sorbent layer(s). In the embodiment shown in FIG. 9A a first conductive film layer 320 is disposed on one side of the membrane 10′ and a second layer 340 is disposed on the opposite of the membrane, with each layer disposed on the sorbent layers 220 and 240 of the membrane 10′. As with the previously discussed embodiments, the conductive film layers 320 and 340 provide heat to the regenerative sorbent membrane for release of CO₂ captured in the sorbent layer.

In one embodiment, wherein the inner support layer 100 is comprised of an inert polymer solid support, an inorganic solid support a metal organic composite solid support, or an elastomeric solid support. Examples of polymer solid supports can comprise Polydimethylsiloxane (PDMS), Polytetrafluoroethylene (PTFE), polyesters such as poly(ethylene terephthalate) (PET) and polyolefins or other known inert polymers. It may be surface treated with atmospheric plasma or corona treatment to improve the wetting with the subsequent coating layers. The polymers used for this inner layer should be non- or low-interacting with CO₂, maintain structural stability over the required temperature range, and not be water soluble or reactive in humid environments.

In a further embodiment, the sorbent layer comprises a polymeric amine, or a functionalized polymeric amine. In a preferred embodiment the polymeric amine of the sorbent layer is a polyethylenimine (PEI) polymer. PEI shows relatively high CO₂ capture capability and does not require large amounts of energy for desorption of CO₂ (i.e. for sorbent regeneration). The PEI polymer in the sorbent layer can be linear or branched (i.e. containing primary, secondary and tertiary amino groups). The polymeric amine of the sorbent layer may be functionalized with C10 to C16 alkyl alcohols, to further assist in the CO₂ affinity capture.

In other embodiments, the sorbent membrane may comprise a metal organic framework (MOF) sorbent. MOFs are a group of crystalline materials having periodic one-, two-, or three-dimensional coordination networks constructed by metal-based nodes (single cations or clusters) bonded (coordinate covalent bond; dative bond) with bridging organic ligands. Examples of known MOF sorbents that are suitable for CO₂ capture include CALF-20 MOF, MOF-177, M-MOF-74. Mg-MOF-74. The list of possible MOFs and modified MOFs for use in carbon capture is extensive and not possible to be fully captured within this disclosure. Although, those of ordinary skill in the art will understand that this disclosure is not limited to the listed MOFs and extends to all MOFs capable of carbon capture.

The conductive film layer 320 and 340 which are disposed on the sorbent layers 220 and 240, as with previous embodiments, can be prepared from a composition comprising carbon nanotubes (CNTs), a polymeric binder, a dispersing agent, and aqueous solvent. The conductive CNT containing composition is prepared as described in above embodiments and in the examples that follow. The conductive film layers, disposed on either side of the two sorbent layers in FIG. 9A will need to be coupled to electrodes so that a current can be supplied for heating the conductive layer, in order to directly heat the sorbent layers for the desorption process. In one embodiment, the conductive film layers are coupled to a current supply source (1A, 2A, 1B and 2B), comprising a positive and negative electrode pair. For example, bus bars can be coupled to the membrane structures to provide the required electrical supply source so that resistive heating of the conductive film layer can occur. Shown in FIG. 9A, The bus bar connection will be directly coupled with the conductive film layers of the regenerative membrane 10′. In FIG. 9B, the bus bars are represented as structures 30A and 30B, and allow for electrical connection of multiple membranes 10′ in a series, in a membrane assembly structure (to be discussed in further detail below).

In one embodiment, the sorbent layers of regenerative membrane 10′ have a thickness of 0.1 microns to 50 microns. The total thickness of the membrane 10 is about 1 mm to 20 mm, and the conductive film layers have a thickness of about 0.5 micron to 10 microns.

Shown in FIG. 9B is a regenerative membrane assembly for gas separation. The membrane assembly incorporates a plurality of regenerative sorbent membranes 10′, wherein each regenerative sorbent membrane 10′ is arranged in a series and is spaced out by a plurality of gas passageways 20, disposed between each membrane 10′. During operation, a flue gas or air, or gas stream to be separated will enter the passageways 20, and interact with the sorbent layers of each membrane 10′. Carbon dioxide molecules are captured onto the sorbent layers of membranes 10′ and separated from the passing flue gas or air stream entering the passageways 20. The entry of gas is then halted and a desorption process can commence, which will require heating of the sorbent layers in order to release the captured CO₂. This is achieved with supplying a current to the conductive film layers (through the bus bar structures 30A and 30B, wherein one has a positive charge and the other a negative charge). Once the conductive film layers 320 and 340 are resistively heated through the supplied current, the sorbent layers 220 and 240 will also be directly heated by contact with the conductive film layers. As previously disclosed, the conductive film layers are porous and breathable and do not hinder gas permeation to the sorbent layers (see Examples below). The assembly shown in FIG. 9B can be utilized for any gas separation process, where carbon dioxide is to be separated from a passing gas stream.

In further embodiments, methods of making regenerative sorbent membranes are disclosed, in accordance with the above teachings of the present invention. A method of making a regenerative sorbent membrane for use in direct air capture systems, comprises the steps of:
providing a sorbent membrane capable of CO₂ capture; and
disposing a conductive film layer on the sorbent membrane;
   wherein the conductive film layer comprises carbon nanotubes (CNT) dispersed in a polymeric binder; and wherein the conductive film layer is capable of heating the sorbent membrane for desorption of captured CO₂.

In certain embodiments, the conductive film layer is disposed or formed on the porous substrate via a coating method including, a transfer film method, spray coating, spin coating, dip coating, doctor blade coating, screen printing, or any other coating methods known to those in state of the art. In some embodiments the conductive layer is coated directly onto an existing sorbent membrane, or alternatively, the layer is coated onto a porous substrate, then transferred onto a sorbent membrane.

### EXAMPLES

Certain embodiments of the present disclosure are further described with reference to the following experiments and examples. These experiments, examples, and samples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

The tables below show an example of materials used to prepare a conductive CNT coating composition (Table A) and the composition makeup of wet conductive film coating, as compared to a dry coating (i.e., the conductive film layer which remains after the wet applied coating has dried/cured). An aqueous composition is prepared, and once the coating has been applied and cured, the remaining dry coating comprises, CNTs, polymeric binder and dispersant (in this example, CMC).

TABLE A

| | Grams in 1 | | | % of total |
|---|---|---|---|---|
| Materials | gallon | % by wt. | % NVM | solids |
| DI water | 740.49 | 19% | 0.00% | |
| Binder | 2.51 | 0% | 50.00% | 2.48% |
| PD0634* 0.8% CNT | 3085.39 | 81% | 1.60% | 97.52% |
| dispersion | | | | |
| TOTAL | 3828.4 | 100% | 1.32% | 100% |

*PD0634 is 98.4% water, 0.8% CMC and 0.8% SWCNT

TABLE B

| | | % by wt. | | % by wt. |
|---|---|---|---|---|
| Coating | Grams in | (wet | % | (dry |
| Composition | 1 gallon | coating) | NVM | coating) |
| DI Water | 3776.5 | 98.65% | 0 | |
| Binder | 2.51 | 0.07% | 50 | 2.48% |
| Dispersant, (CMC) | 24.68 | 0.64% | 100 | 48.76% |
| SWCNT | 24.68 | 0.64% | 100 | 48.76% |
| TOTAL | 3828.37 | 100.00% | 1.322 | 100% |

### Example 1—Investigations on the Effect of the Substrate Porosity on Ohmic Resistance

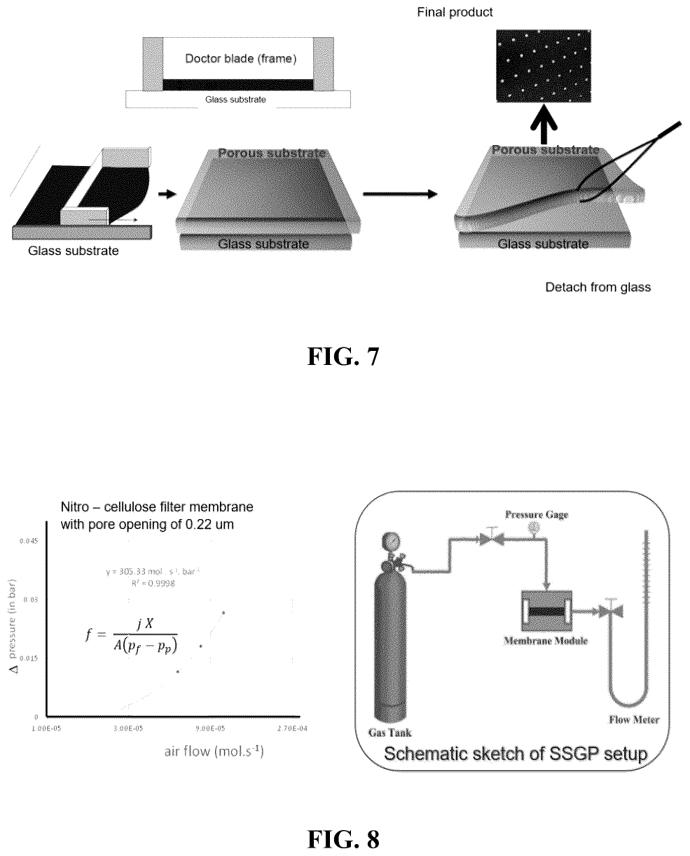

A nonwoven polyester polycarbonate substrate (NWPP, such as MERV 16) with surface pore varying from 3 to 10 microns were tested. The substrates had a thickness of 1.0 mm. A coating formulated with about 80% by weight of 0.8% single wall carbon nanotube dispersion, 0.07% acrylic binder and 19% deionized water was prepared with low shear mixing. Coating of the conductive film layers on these substrates was carried out through a transfer film process, shown in FIG. 7. A doctor blade frame was used to uniformly spread a prepared conductive layer composition on a glass substrate (with a desired thickness preselected prior to deposition). The NWPP porous substrates were disposed on top of the formed filmed, and once adhesion and curing of the conductive film is complete, the substrate is peeled off and removed from the glass substrate, with the conductive film attached onto the porous substrate.

A conductive film layer having a 10 mil (or 254 micron) wet thickness was formed and tested on Non-Woven Polyester Polycarbonates substrates (NWP) having MERV rating of 8 and 16 marked KS0001 and KS0002, respectively. MERV rating indicates what air particle size the filter would capture. The Non-Woven-Polyester substrate, MERV 16 and MERV 8 with good thermal stability up to 180° C. as indicated by thermal-gravimetric-analysis (TGA) has a pore opening 3 micron and above 10 micron, respectively. The results are shown in the Table 3 below.

TABLE 3

| | Wet layer | | | | | |
|---|---|---|---|---|---|---|
| | thickness | Initial T | | T | | R |
| Substrate | (mils) | (° C.) | Current (A) | (° C.) | Voltage | (Ohm) |
| KS0001 | 10 | 20 | 1.21 | 30 | 5.5 V | 4.5 |
| KS0002 | | | | | 4.5 V | 3.7 |

### Example 2—Effect of Thickness of Conductive Layer on Ohmic Resistance

The effect of the thickness of the deposited conductive layer on the Ohmic resistance of the conductive layer were investigated. A coating formulated with about 80% by weight of 0.8% single wall carbon nanotube dispersion, 0.07% acrylic binder and 19% deionized water was prepared with low shear mixing. The substrates used were AC Safe AC-302/50R Economy Plus Air Conditioner Filter 50 Foot Roll with low MERV rating (MERV 8) marked as KS0001, with conductive coating of 5 mil, and one of 10 mil wet thickness disposed thereon through the transfer coating process shown in FIG. 7. The results are shown in the Table 4 below.

TABLE 4

| | Wet layer | Initial T | Current | | | R |
|---|---|---|---|---|---|---|
| Substrate | thickness | (° C.) | (A) | T (° C.) | Voltage | (Ohm) |
| KS0001 | 5 mil | 20 | 1.21 | 30 | 6 V | 5.0 |
| KS0001 | 10 mil | | | | 5.5 V | 4.5 |

### Example 3—Gas Permeation Performance after Coating with Conductive Layer

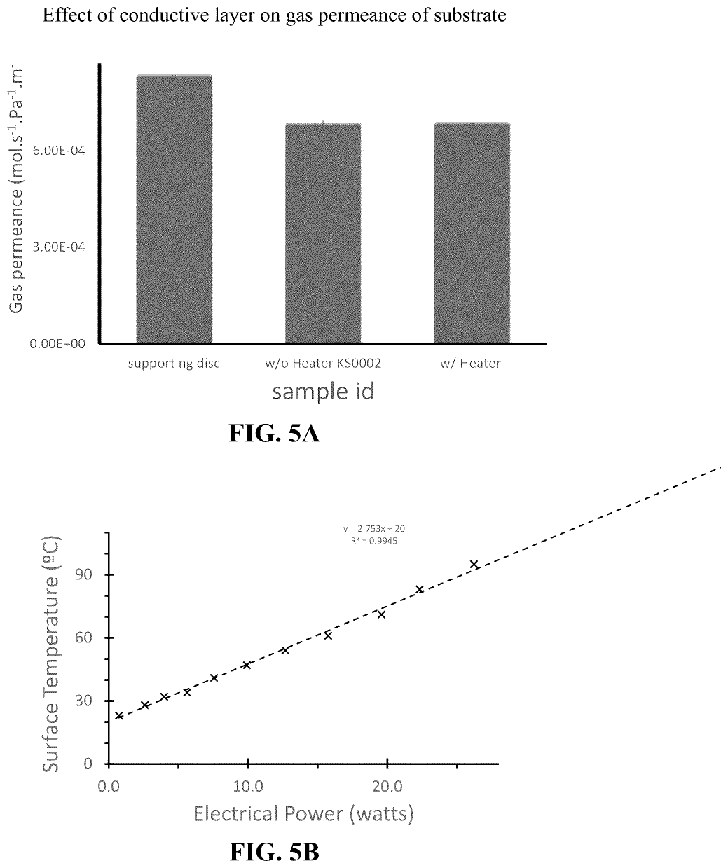

To determine the effect a conductive layer coating would have on the gas permeation properties of a porous substrate, test were conducted on gas permeation parameters of uncoated vs. coated Non-Woven-Polyester (NWP) substrates. A coating formulated with about 80% by weight of 0.8% single wall carbon nanotube dispersion, 0.07% acrylic binder and 19% deionized water was prepared with low shear mixing. A Non-Woven-Polyester (NWP) MERV 16 substrate with pore opening of 3 microns was coated with a conductive layer with 10 mil wet thickness. An Stationary-Single-Gas-Permeation (SSGP) testing setup was prepared, as shown in FIG. 8, where feed side pressure of gases was kept constant at about 1.04 bar. The permeate side was maintained at atmospheric pressure. Comparative results of the effect of the coating on the gas permeation of the substrate are shown in the Table below and also in FIG. 5A. As can be seen through the disclosed data and also FIG. 5A the substrates which had the conductive layer disposed thereon did not have a reduction in gas permeance (i.e. gas transport), when compared to the uncoated substrates.

TABLE 5

| | w/ heater KS0002: | | | w/o heater KS0002: | | |
|---|---|---|---|---|---|---|
| | Mass Flow | Pressure | [symbol] nce | Mass Flow | [symbol] essure | Pressure |
| Test#: | (SCMM): | (Pa): | (mol · s − 1 · Pa [symbol] | (SCMM): | (P [symbol] | (Pa): |
| 1 | 131 | 633 | 6.78E−04 | 126 | 593 | 6.959E−04 |
| 2 | 128 | 621 | 6.75E−04 | 126 | 601 | 6.867E−04 |
| 3 | 128 | 619 | 6.77E−04 | 125 | 619 | 6.614E−04 |
| 4 | 125 | 599 | 6.83E−04 | 124 | 616 | 6.593E−04 |
| 5 | 127 | 609 | 6.83E−04 | 127 | 609 | 6.830E−04 |

| | | | |
|---|---|---|---|
| average | 6.79E−04 | average | 6.77E−04 |
| STDEV | 3.71884E−06 | STDEV | 1.61534E−05 |

[symbol]

indicates data missing or illegible when filed

### Example 4—Heating Profile Using Conductive Layer Vs. Traditional Heating Means

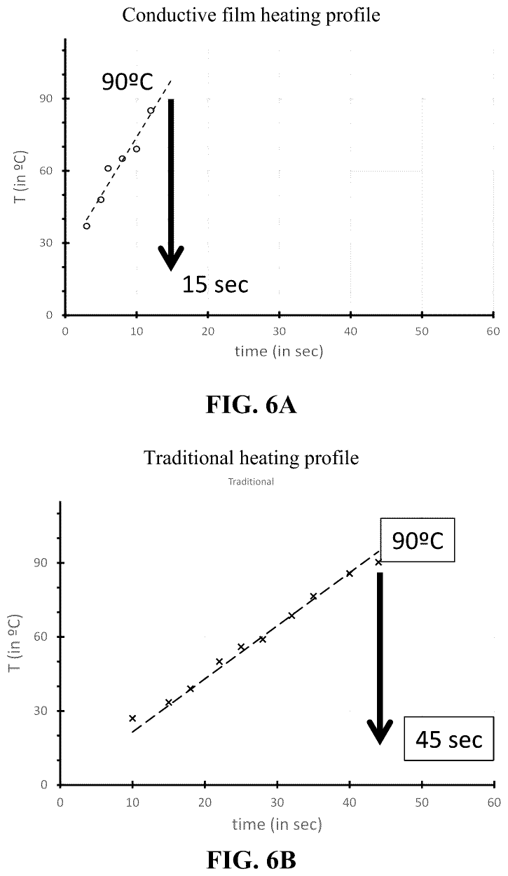

The heating rate of substrates using a conductive layer was compared to substrates heated through traditional means (using a heating tape). The graph in FIG. 6A shows the heating profile achieved with a conductive coating layer on a substrate, and FIG. 6B shows the heating profile achieved using traditional heating tape. For this comparison, The Non-Woven-Polyester substrate, MERV 16 with 3-micron pore opening was used. The substrate having a conductive film layer reached 90 degrees Celsius in 15 seconds, while the substrate heating in a traditional way took 45 seconds to reach 90 degrees Celsius.

The above specification, examples and data provide a complete description of the manufacture and use of the composition of the disclosure. Since many embodiments of the disclosure can be made without departing from the spirit and scope of the disclosure, the disclosure resides in the claims hereinafter appended. Further embodiments and examples of the invention are also illustrated in the following numbered clauses.
Clause 1. A regenerative sorbent membrane, comprising:
   a macroporous support layer;
   a mesoporous layer;
   a sorbent comprising a moiety with CO₂ affinity;
   a conductive film layer;
wherein the conductive film layer is configured to provide heat to the regenerative sorbent membrane for release of CO₂ captured by the sorbent.
Clause 2. The regenerative sorbent membrane of clause 1, wherein the regenerative sorbent membrane is utilized in a direct air capture system for CO₂ removal.
Clause 3. The regenerative sorbent membrane of clause 1, wherein the conductive film layer comprises carbon nanotubes, a polymeric binder, and optionally a dispersing agent.
Clause 4. The regenerative sorbent membrane of clause 1, wherein the carbon nanotubes are comprised of SWCNT, DWCNT, MWCNT, fullerenes, or a combination thereof.
Clause 5. The regenerative sorbent membrane of clause 1, wherein the conductive film layer has a thickness of about 1.0 to 5 microns.
Clause 6. The regenerative sorbent membrane of clause 1, wherein the conductive film layer has a resistance of about 3-5 Ohm and a heating rate of about 7° C. to 10° C. per second.
Clause 7. The regenerative sorbent membrane of clause 1, wherein the conductive film layer has a gas permeance (f) of about 7e-4 mol·s⁻¹·Pa⁻¹·m⁻²
Clause 8. The regenerative sorbent membrane of clause 1, wherein the macroporous, mesoporous layer or sorbent comprises a zeolite, a metal organic framework (MOF), alumina, silica, silica alumina, titania, activated carbon, organically modified ceramic materials, organic polymers, or a combination thereof.
Clause 9. The regenerative sorbent membrane of clause 1, wherein the conductive film layer has a gas permeance (f) that is about 10% to 20% higher than that of the sorbent or mesoporous layer.
Clause 10. The regenerative sorbent membrane of clause 1, further comprising a pair of electrodes coupled to the conductive film layer for providing a current to the conductive film layer.
Clause 11. The regenerative sorbent membrane of clause 1, wherein the conductive film layer comprises CNTs, a polymeric binder, and a dispersing agent.
Clause 12. The regenerative sorbent membrane of clause 11, wherein the polymeric binder is selected from a group consisting of acrylic polymer, acrylonitrile butadiene polymer, urethane polymer, epoxy polymer, or a combination thereof.
Clause 13. The regenerative sorbent membrane of clause 1, wherein the conductive film layer comprises a porous substrate, having pores size of about 3 microns to about 10 microns.
Clause 14. The regenerative sorbent membrane of clause 13, wherein the porous substrate comprises a nonwoven polyester polycarbonate.
Clause 15. The regenerative sorbent membrane of clause 13, wherein the conductive film layer is formed via a coating method selected from the group consisting of transfer film method, spray coating, spin coating, dip coating, doctor blade coating, screen printing, and or a combination thereof.
Clause 16. The regenerative sorbent membrane of clause, wherein the conductive film layer comprises about 30-60 wt. % of CNTs.
Clause 17. A method of making a regenerative sorbent membrane for use in direct air capture systems, the method comprising:
   providing a sorbent membrane capable of CO₂ capture;
   disposing a conductive film layer on the sorbent membrane;
wherein the conductive film layer comprises carbon nanotubes (CNT) dispersed in a polymeric binder; and
wherein the conductive film layer is capable of heating the sorbent membrane for desorption of captured CO₂.
Clause 18. The method of clause 17, wherein the carbon nanotubes are comprised of SWCNT, DWCNT, MWCNT, fullerenes, or a combination thereof.
Clause 19. The method of clause 17, wherein the conductive film layer has a thickness of about 1.0 to 5. 0 microns.
Clause 20. The method of clause 17, wherein the conductive film layer has a resistance of about 1-7 Ohm and a heating rate of about 7° C. to 10° C. per second.
Clause 21. The method of clause 17, wherein the conductive film layer has a gas permeance (f) of about 7e-4 mol·s⁻¹·Pa⁻¹·m⁻²
Clause 22. The method of clause 17, wherein the sorbent membrane comprises:
   a macroporous support layer;
   a mesoporous layer, and
   a sorbent having a moiety with CO₂ affinity.
Clause 23. The method of clause 22, wherein macro porous layer, mesoporous layer or sorbent comprises a zeolite, a metal organic framework (MOF), alumina, silica, silica alumina, titania, activated carbon, organically modified ceramic materials, organic polymers, or a combination thereof.
Clause 24. The method of clause 17, wherein the conductive film layer has a gas permeance (f) that is about 10% to 20% higher than that of the sorbent or mesoporous layer.
Clause 25. The method of clause 17, wherein the sorbent membrane further comprises a pair of electrodes coupled to the conductive film layer for providing a current to the conductive film layer.
Clause 26. The method of clause 17, wherein the polymeric binder is selected from a group consisting of acrylic polymer, acrylonitrile butadiene polymer, urethane, epoxy, or a combination thereof.
Clause 27. The method of clause 17, wherein the conductive film layer comprises, and about 30-60 wt. % of CNTs.
Clause 28. A regenerative sorbent membrane, comprising:
   an inner support layer;
   at least one sorbent layer having CO₂ affinity, disposed on the inner support layer;
   at least one conductive film layer disposed on the at least one sorbent layer;
wherein the at least one conductive film layer provides heat to the regenerative sorbent membrane for release of CO₂ captured in the sorbent layer.
Clause 29. The regenerative sorbent membrane of clause 28, wherein the inner support layer is comprised of an inert polymer solid support, an inorganic solid support a metal organic composite solid support, or an elastomeric solid support.
Clause 30. The regenerative sorbent membrane of clause 28, wherein the at least one sorbent layer comprises a polymeric amine.
Clause 31. The regenerative sorbent membrane of clause 30, wherein the polymeric amine is a polyethylenimine.
Clause 32. The regenerative sorbent membrane of clause 28, wherein the at least one sorbent layer comprises a metal organic framework (MOF) sorbent.
Clause 32. The regenerative sorbent membrane of clause 28, wherein the conductive film layer comprises carbon nanotubes (CNTs), a polymeric binder, and a dispersing agent.
Clause 33. The regenerative sorbent membrane of clause 28, wherein the at least one conductive film layer is coupled to a current supply source, comprising a positive and negative electrode pair.
Clause 34. The regenerative sorbent membrane of clause 28, wherein the at least one sorbent layer has a thickness of 0.1 microns to 50 microns.
Clause 35. The regenerative sorbent membrane of clause 28, wherein the total thickness of the membrane is 1 mm to 20 mm.
Clause 36. The regenerative sorbent membrane of clause 28, wherein the at least one conductive film layer has a thickness of about 0.5 micron to 10 microns.
Clause 37. The regenerative sorbent membrane of clause 32, wherein the at least one conductive film layer comprises about 30-60 wt. % of CNTs.
Clause 38. A regenerative membrane assembly for gas separation, comprising:
   a plurality of regenerative sorbent membranes, wherein each regenerative sorbent membrane comprises,
      an inner support layer;
      at least one sorbent layer having CO₂ affinity, disposed on the inner support layer;
      at least one conductive film layer disposed on the at least one sorbent layer;
         wherein the at least one conductive film layer provides heat to the regenerative sorbent membrane for release of CO₂ captured in the sorbent layer.
Clause 39. The regenerative membrane assembly of clause 38, wherein the plurality of regenerative sorbent membranes are arranged in a series having a gas passageway disposed between each membrane.
Clause 40. The regenerative membrane assembly of clause 38, for use in a direct air capture system (DAC).

What is claimed is:

1. A regenerative sorbent membrane, comprising:
a macroporous support layer;
a mesoporous layer;
a sorbent comprising a moiety with CO₂ affinity;
a conductive film layer;
wherein the conductive film layer is configured to provide heat to the regenerative sorbent membrane for release of CO₂ captured by the sorbent.

2. The regenerative sorbent membrane of claim 1, wherein the regenerative sorbent membrane is utilized in a direct air capture system for CO₂ removal.

3. The regenerative sorbent membrane of claim 1, wherein the conductive film layer comprises carbon nanotubes (CNTs), a polymeric binder, and optionally a dispersing agent.

4. The regenerative sorbent membrane of claim 1, wherein the carbon nanotubes (CNTs) are comprised of SWCNT, DWCNT, MWCNT, fullerenes, or a combination thereof.

5. The regenerative sorbent membrane of claim 1, wherein the conductive film layer has a thickness of about 1.0 to 5 microns.

6. The regenerative sorbent membrane of claim 1, wherein the conductive film layer has a resistance of about 3-5 Ohm and a heating rate of about 7° C. to 10° C. per second.

7. The regenerative sorbent membrane of claim 1, wherein the conductive film layer has a gas permeance (f) of about 7e-4 mol·s⁻¹·Pa⁻¹·m⁻²

8. The regenerative sorbent membrane of claim 1, wherein the macroporous, mesoporous layer or sorbent comprises a zeolite, a metal organic framework (MOF), alumina, silica, silica alumina, titania, activated carbon, organically modified ceramic materials, organic polymers, or a combination thereof.

9. The regenerative sorbent membrane of claim 1, wherein the conductive film layer has a gas permeance (f) that is about 10% to 20% higher than that of the sorbent or mesoporous layer.

10. The regenerative sorbent membrane of claim 1, further comprising a pair of electrodes coupled to the conductive film layer for providing a current to the conductive film layer.

11. The regenerative sorbent membrane of claim 3, wherein the polymeric binder is selected from a group consisting of acrylic polymer, acrylonitrile butadiene polymer, urethane polymer, epoxy polymer, or a combination thereof.

12. The regenerative sorbent membrane of claim 1, wherein the conductive film layer comprises a porous substrate, having pores size of about 3 microns to about 10 microns.

13. The regenerative sorbent membrane of claim 12, wherein the porous substrate comprises a nonwoven polyester polycarbonate.

14. The regenerative sorbent membrane of claim 3, wherein the conductive film layer comprises about 30-60 wt. % of CNTs.

15. A regenerative sorbent membrane, comprising:
an inner support layer;
at least one sorbent layer having CO₂ affinity, disposed on the inner support layer;
at least one conductive film layer disposed on the at least one sorbent layer;
wherein the at least one conductive film layer provides heat to the regenerative sorbent membrane for release of CO₂ captured in the sorbent layer.

16. The regenerative sorbent membrane of claim 15, wherein the inner support layer is comprised of an inert polymer solid support, an inorganic solid support a metal organic composite solid support, or an elastomeric solid support.

17. The regenerative sorbent membrane of claim 15, wherein the at least one sorbent layer comprises a polymeric amine.

18. The regenerative sorbent membrane of claim 15, wherein the conductive film layer has a thickness of about 0.5 micron to 10 microns and comprises carbon nanotubes (CNTs), a polymeric binder, and a dispersing agent.

19. The regenerative sorbent membrane of claim 15, wherein the at least one conductive film layer is coupled to a current supply source, comprising a positive and negative electrode pair.

20. A regenerative membrane assembly for gas separation, comprising:
a plurality of regenerative sorbent membranes, wherein each regenerative sorbent membrane comprises:
an inner support layer;
at least one sorbent layer having CO₂ affinity, disposed on the inner support layer;
at least one conductive film layer disposed on the at least one sorbent layer;
wherein the at least one conductive film layer is configured to provide heat to the regenerative sorbent membrane for release of CO₂ captured in the sorbent layer.
